(19) United States
(12) Patent Application Publication
(10) Pub. No.: US 2010/0060588 A1
(43) Pub. Date: Mar. 11, 2010

(54) TEMPORALLY SEPARATE TOUCH INPUT

(75) Inventor: Jeffrey Fong, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/206,763

(22) Filed: Sep. 9, 2008

(51) Int. Cl. G06F 3/041

(52) U.S. Cl. 345/173

(57) ABSTRACT

A method of processing touch input includes recognizing a first touch input, and then, after conclusion of the first touch input, recognizing a second touch input temporally separate from the first touch input. The temporally separate combination of the first touch input and the second touch input is then translated into a multi-touch control.

### BACKGROUND

Computing devices may be designed with a variety of different form factors. Different form factors may utilize different input mechanisms, such as keyboards, mice, track pads, touch screens, etc. The enjoyment a user experiences when using a device, and the extent to which a user may fully unleash the power of a device, is thought to be at least partially influenced by the ease with which the user can cause the device to perform desired functions. Accordingly, an easy to use and full featured input mechanism is thought to contribute to a favorable user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

The processing of touch inputs is disclosed. A first touch input is recognized, and then, after conclusion of the first touch input, a second touch input temporally separate from the first touch input is recognized. The temporally separate combination of the first touch input and the second touch input is translated into a multi-touch control.

### BRIEF DESCRIPTION OF THE DRAWINGS

FIG. 1 shows a computing device configured to process temporally separate touch inputs in accordance with an embodiment of the present disclosure.

FIG. 2 is a process flow of a method of translating single-touch input into multi-touch control in accordance with an embodiment of the present disclosure.

FIG. 3 shows temporally separate touch inputs being translated into a multi-touch scale control that increases the scale of an image presented by a display of a computing device.

FIG. 4 shows temporally separate touch inputs being translated into a multi-touch scale control that decreases the scale of an image presented by a display of a computing device.

FIG. 5 shows temporally separate touch inputs being translated into a multi-touch rotate control that rotates an image presented by a display of a computing device.

### DETAILED DESCRIPTION

The present disclosure is directed to methods of translating temporally separate touch inputs into multi-touch controls. The methods described below allow a device that is capable of analyzing only one touch input at any given time to process a full range of multi-touch controls, previously available only to devices specifically configured to analyze two or more temporally overlapping touch inputs.

The methods described below may additionally or alternatively be used as an alternative method of issuing multi-touch controls on a device that is configured to analyze two or more temporally overlapping touch inputs. This may allow a user to issue a multi-touch control using only one hand—for example, using a right thumb to perform temporally separate touch inputs while holding a computing device in the right hand, as opposed to using a right thumb and a right index finger to perform temporally overlapping touch inputs while holding the computing device in the left hand.

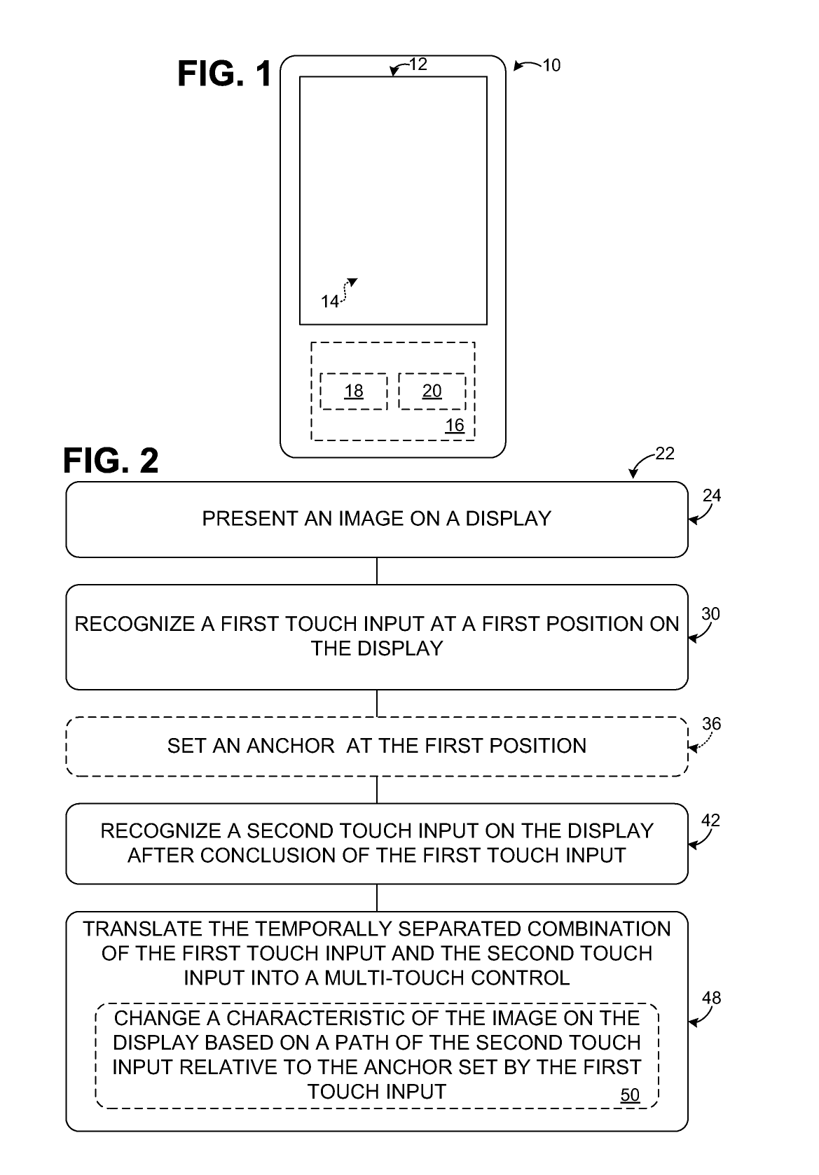

FIG. 1 somewhat schematically shows a nonlimiting example of a computing device 10 configured to interpret temporally separate touch inputs into multi-touch controls. Computing device 10 includes a display 12 configured to visually present an image. Display 12 may include a liquid crystal display, light-emitting diode display, plasma display, cathode ray tube display, rear projection display, or virtually any other suitable display.

Computing device 10 also includes a touch-input subsystem 14 configured to recognize touch input on the display. The touch-input subsystem may optionally be configured to recognize multi-touch input. The touch-input subsystem may utilize a variety of different touch-sensing technologies, which may be selected to cooperate with the type of display used in a particular embodiment. The touch-input subsystem may be configured to detect a change in an electric field near the display, a change in pressure on the display, and/or another change on or near the display. Such changes may be caused by a touch input occurring at or near a particular position on the display, and such changes may therefore be correlated to touch input at such positions. In some embodiments, the display and the touch-input subsystem may share at least some components, such as a capacitive touch-screen panel or a resistive touch-screen panel.

Computing device 10 may also include a control subsystem 16 configured to translate single-touch input into multi-touch control. As an example, the control subsystem may be configured to manipulate an image on a display based on the collective interpretation of two or more temporally separate touch inputs. The control subsystem may include a logic subsystem 18 and a memory 20. The control subsystem, logic subsystem, and memory are schematically illustrated as dashed rectangles in FIG. 1.

Logic subsystem 18 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, change the state of one or more devices (e.g., display 12), or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory 20 may include one or more physical devices configured to hold data and/or instructions that, when executed by the logic subsystem, cause the logic subsystem to implement the herein described methods and processes. Memory 20 may include removable media and/or built-in devices. Memory 20 may include optical memory devices, semiconductor memory devices, and/or magnetic memory devices, among others. Memory 20 may include portions with one or more of the following characteristics: volatile, nonvolatile, dynamic, static, read/write, read-only, random access, sequential access, location addressable, file addressable, and content addressable. In some embodiments, logic subsystem 18 and memory 20 may be integrated into one or more common devices and/or computing systems (e.g., a system on a chip or an application-specific integrated circuit).

Computing device 10 may by a hand-held computing device (e.g., personal data assistant, personal gaming device, personal media player, mobile communications device, etc.), a laptop computing device, a stationary computing system, or virtually any other computing device capable of recognizing touch input. In some embodiments, the display and may be integrated into a common housing with the control subsystem, and in other embodiments the device may be connected to the control subsystem via a wired or wireless data connection. In either case, the display is considered to be part of the computing device for purposes of this disclosure.

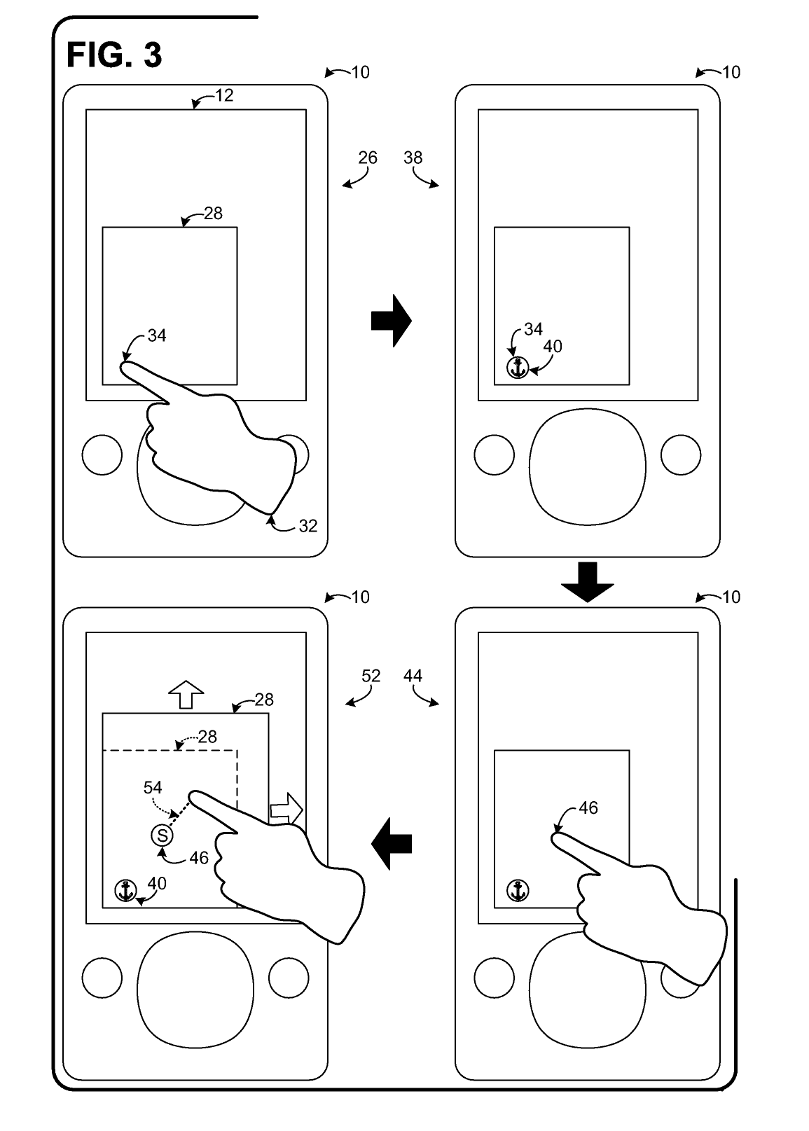

FIG. 2 shows a process flow of a method 22 of translating single-touch input into multi-touch control. At 24, method 22 includes presenting an image on a display. For example, at 26, FIG. 3 shows computing device 10 presenting an image 28 on display 12. Image 28 is schematically represented as a white rectangle in FIG. 3. It is to be understood, however, that an image may take a variety of different forms, including, but not limited to, a variety of different graphical user interface elements. As nonlimiting examples, such an image may be a photo, a video, a web page, a game, a document, an interactive user interface, or virtually any other content that may be displayed by display 12. The image may constitute only a portion of what is presented by the display, or the image may constitute the entirety of what is presented by the display.

At 30, method 22 of FIG. 2 includes recognizing a first touch input at a first position on the display. For example, at 26, FIG. 3 schematically shows a user 32 touching display 12 at a first position 34. The computing device may utilize a touch-input subsystem to detect the touch input and determine where on the display the touch input occurred. As described above, virtually any touch sensing technology may be used without departing from the scope of this disclosure.

Turning back to FIG. 2, at 36, method 22 includes setting an anchor at the first position. The anchor can be used to remember the location of the position where the first touch input occurred, so that subsequent touch inputs can be compared to this position. In some embodiments, an anchor indicator may be displayed at the position where the first touch input occurred, thus giving a user a visual reference for subsequent touch inputs. For example, at 38, FIG. 3 shows an anchor indicator 40 displayed at first position 34. It is noted that the anchor indicator remains displayed after the conclusion of the first touch input, although it may optionally be initially displayed before the conclusion of the first touch input.

A computing device may be configured to set an anchor responsive to particular types of input. In some embodiments, a computing device may be configured to set an anchor at a given position if a touch input is held at the given position for a predetermined period of time. In such embodiments, if the touch input is not held for the predetermined duration, an anchor will not be set. In some embodiments, an anchor may be set by double tapping or triple tapping a given position. In other embodiments, an anchor may be set responsive to a touch input performed in conjunction with a non-touch input (e.g., pressing a button). While it may be beneficial to set an anchor point responsive to only certain types of inputs, it is to be understood that the present disclosure is not limited to any particular type of input for setting the anchor.

At 42 of FIG. 2, method 22 includes recognizing a second touch input on the display after conclusion of the first touch input. In other words, the first touch input and the second touch input are temporally separate. The first touch input and the second touch input do not overlap in time. At 44, FIG. 3 shows the user beginning a second touch input by touching display 12 at starting position 46.

Turning back to FIG. 2, at 48, method 22 includes translating a temporally separate combination of the first touch input and the second touch input into a multi-touch control. Temporally separate touch inputs can be translated into a variety of different types of controls without departing from the scope of this disclosure. For example, temporally separate touch inputs may be translated into controls for opening or closing an application, issuing commands within an application, performing a shortcut, etc. Some translated controls may be controls for manipulating an image on a display (e.g., zoom control, rotate control, etc.).

As indicated at 50, method 22 may optionally include changing a characteristic of an image on a display based on a path of a second touch input relative to the anchor set by a first touch input. For example, at 52, FIG. 3 shows the user performing a touch input having a path 54 that is directed away from the anchor set by the first touch input, as indicated by anchor indicator 40. In other words, a distance between the anchor and the second touch input is increasing. FIG. 3 also shows that a scale of image 28 increases if path 54 is directed away from the anchor set by the first touch input. In some embodiments, the amount of scaling may be adjusted by the speed with which the second touch input moves away from the anchor and/or the angle at which the second touch input moves away from the anchor.

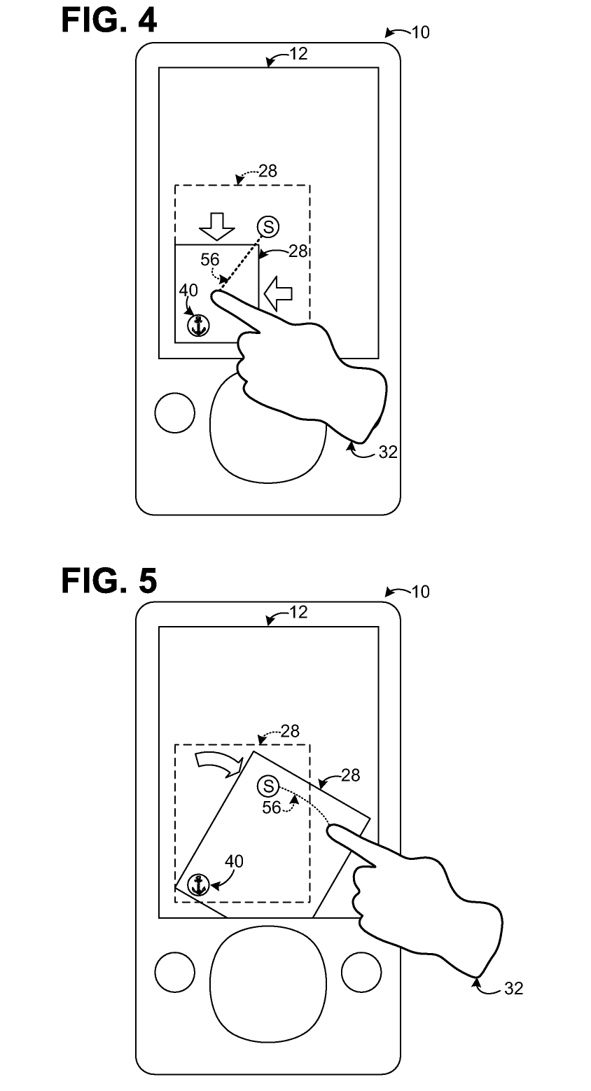

As another example, FIG. 4 shows user 32 performing a touch input having a path 56 that is directed towards the anchor set by the first touch input. In other words, a distance between the anchor and the second touch input is decreasing. FIG. 4 also shows that a scale of image 28 decreases if path 56 is directed towards the anchor set by the first touch input. In some embodiments, the amount of scaling may be adjusted by the speed with which the second touch input moves towards the anchor and/or the angle at which the second touch input moves towards the anchor.

As still another example, FIG. 5 shows user 32 performing a touch input having a path 58 that is directed around the anchor set by the first touch input. FIG. 5 also shows that image 28 is rotated if a path of the second touch input is directed around the anchor set by the first touch input. In some embodiments, the amount of rotation may be adjusted by the speed with which the second touch input moves around the anchor and/or the distance from which the second touch input moves around the anchor.

The above described multi-touch-type controls are nonlimiting examples of the various different controls that may be translated from temporally separate touch inputs. In some embodiments, two or more different controls may be aggregated from a single set of temporally separate touch inputs (e.g., scale and rotate responsive to touch input moving both away from and around anchor).

Once set, an anchor may be released responsive to several different events and/or scenarios. For example, after an anchor is set, it may be released if a compatible second touch input is not performed within a threshold time limit. As another example, an anchor may be released after a second touch input is completed and/or a characteristic of an image is changed. By releasing the anchor, a computing device may become ready to process touch input that does not need to be considered with temporally separate touch input and/or touch input for setting a different anchor.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of manipulating an image on a display, the method comprising:
presenting the image on the display;
recognizing a first touch input at a first position on the display;
setting an anchor at the first position;
after conclusion of the first touch input, recognizing a second touch input on the display; and
changing a characteristic of the image on the display based on a path of the second touch input relative to the anchor set by the first touch input.

2. The method of claim 1, where changing a characteristic of the image on the display includes increasing a scale of the image if a path of the second touch input is directed away from the anchor set by the first touch input.

3. The method of claim 1, where changing a characteristic of the image on the display includes decreasing a scale of the image if a path of the second touch input is directed towards the anchor set by the first touch input.

4. The method of claim 1, where changing a characteristic of the image on the display includes rotating the image if a path of the second touch input is directed around the anchor set by the first touch input.

5. The method of claim 1, further comprising displaying an anchor indicator at the first position after conclusion of the first touch input.

6. The method of claim 1, where an anchor is set only if a touch input is held at a given position for a predetermined period of time before that touch input is concluded.

7. The method of claim 1, further comprising releasing the anchor after the characteristic of the image is changed.

8. The method of claim 1, where recognizing a first touch input on the display includes detecting a change in an electric field near the display.

9. The method of claim 1, where recognizing a first touch input on the display includes detecting a change in pressure on the display.

10. A method of processing touch input, the method comprising:
recognizing a first touch input;
after conclusion of the first touch input, recognizing a second touch input temporally separate from the first touch input; and
translating a temporally separate combination of the first touch input and the second touch input into a multi-touch control.

11. The method of claim 10, where the multi-touch control is a zoom control for increasing a scale of an image if a path of the second touch input is directed away from a position of the first touch input.

12. The method of claim 10, where the multi-touch control is a zoom control for decreasing a scale of an image if a path of the second touch input is directed toward a position of the first touch input.

13. The method of claim 10, where the multi-touch control is a rotation control for rotating an image if a path of the second touch input is directed around a position of the first touch input.

14. The method of claim 10, further comprising displaying an anchor indicator at a position of the first touch input after conclusion of the first touch input.

15. A computing device, comprising:
a display configured to visually present an image;
a touch-input subsystem configured to recognize touch input on the display; and
a control subsystem configured to:
set an anchor at a first position responsive to a first touch input recognized at a first position by the touch-input subsystem; and
change a characteristic of the image on the display responsive to a second touch input recognized after conclusion of the first touch input, the control subsystem configured to change the characteristic of the image based on a path of the second touch input relative to the anchor.

16. The computing device of claim 15, where the control subsystem is configured to increase a scale of the image on the display if a path of the second touch input is directed away from the anchor set by the first touch input.

17. The computing device of claim 15, where the control subsystem is configured to decrease a scale of the image on the display if a path of the second touch input is directed towards the anchor set by the first touch input.

18. The computing device of claim 15, where the control subsystem is configured to rotate the image if a path of the second touch input is directed around the anchor set by the first touch input.

19. The computing device of claim 15, where the control subsystem is configured to cause the display to display an anchor indicator at the first position responsive to the first touch input.

20. The computing device of claim 15, where the control subsystem is configured to set an anchor only if a touch input is held at a given position for a predetermined period of time before that touch input is concluded.
